(19) United States
(12) Patent Application Publication
(10) Pub. No.: US 2010/0121564 A1
(43) Pub. Date: May 13, 2010

(54) REMOTE GUIDE SYSTEM, REMOTE GUIDE METHOD AND REMOTE GUIDE DEVICE

(75) Inventors: Yuichi Kobayashi, Tokyo (JP); Yuzuru Fukuda, Tokyo (JP)

Correspondence Address: FOLEY AND LARDNER LLP;SUITE 500, 3000 K STREET NW, WASHINGTON, DC, 20007, US

(73) Assignee: Hitachi Automotive Systems, Ltd.

(21) Appl. No.: 12/608,498

(22) Filed: Oct. 29, 2009

(30) Foreign Application Priority Data
Oct. 31, 2008 (JP) 2008-280705

(51) Int. Cl. G01C 21/36

(52) U.S. Cl. 701/201

(57) ABSTRACT

A remote guide system is featured by including: a server with a route search processing unit for searching a route from a departing place to a target place so as to distribute a search result, and a route guide processing unit for distributing guide information for guiding a user from the departing place to the target place by passing the searched route; and a moving object connected to the server, and with a route search request processing unit for transmitting a request of a route search to the server, and a present position processing unit for correcting a present position by employing map image data and for guiding the user based upon the guide information acquired from the server.

### INCORPORATION BY REFERENCE

The present invention claims priority from Japanese patent application JP 2008-280705 on Oct. 31, 2008, the content of which is hereby incorporated by reference into this application.

### BACKGROUND OF THE INVENTION

Different from conventional stand-alone type car navigation systems, thin client type navigation systems have been disclosed in, for instance, JP 2000-383513 (Patent Document 1). That is, while all functions and all information which are required for car navigation are configured on servers, the thin client type navigation systems provide route information and guide information with respect to moving objects in combination with maps, and the like with respect to moving objects by utilizing wireless communication systems such as portable telephones.

### SUMMARY OF THE INVENTION

In the conventional thin client type navigation systems, only necessary data portions of map data where routes are drawn are transmitted in connection with movements of moving objects. As a result, the map data must be continuously received via communications, so that the conventional thin client type navigation systems cannot be utilized at places where communication environments are not properly established.

Also, since the map data are received via the communications, there is a risk that communication traffic amounts may be probably increased.

Moreover, in the case that moving objects are such apparatuses (for instance, portable telephones) that electric power of power sources is limited, since battery power is consumed by communications, time durations during which transmitting/receiving operations can be carried out are also limited.

To solve the above-described problems, a remote guide system of the present invention is provided with the below-mentioned arrangements: That is, the remote guide system is featured by comprising: a server including a route search processing unit for searching a route from a departing place to a target place so as to distribute a search result, and a route guide processing unit for distributing guide information for guiding a user from the departing place to the target place by passing the searched route; and a processing apparatus connected to the server, and including a route search request processing unit for transmitting a request of a route search to the server, and a present position processing unit for guiding the user based upon the guide information acquired from the server.

In accordance with the present invention, the navigation functions suitable for the processing apparatus can be provided.

### BRIEF DESCRIPTION OF THE DRAWINGS

FIG. 1 is a structural diagram of a remote guide system designed for a moving object.

FIG. 2 is a diagram for indicating one example of route search result information.

FIG. 3 is a diagram for representing one example of route information.

FIG. 4 is a diagram for showing one example of crossing information.

FIG. 5 is a diagram for indicating one example of guide information.

FIG. 6 is a flow chart of a route search request processing unit, a route search processing unit, and a route guide processing unit.

FIG. 7 is a flow chart of a present position processing unit and the route guide processing unit.

FIG. 8 is a flow chart of the present position processing unit.

### DESCRIPTION OF THE EMBODIMENTS

Referring now to drawings, a description is made of an embodiment mode. The present embodiment mode is featured: That is, a moving object corrects positional information by employing map image data held in the moving object based upon the positional information acquired by a position detecting apparatus mounted on the moving object and the moving object transmits both the corrected positional information of the present position and positional information of a target place to a remote guide server; the remote guide server forms route information and guide information from the present position to the target place; and the moving object outputs guide information in response to the formed route information and guide information, and also, the positional information.

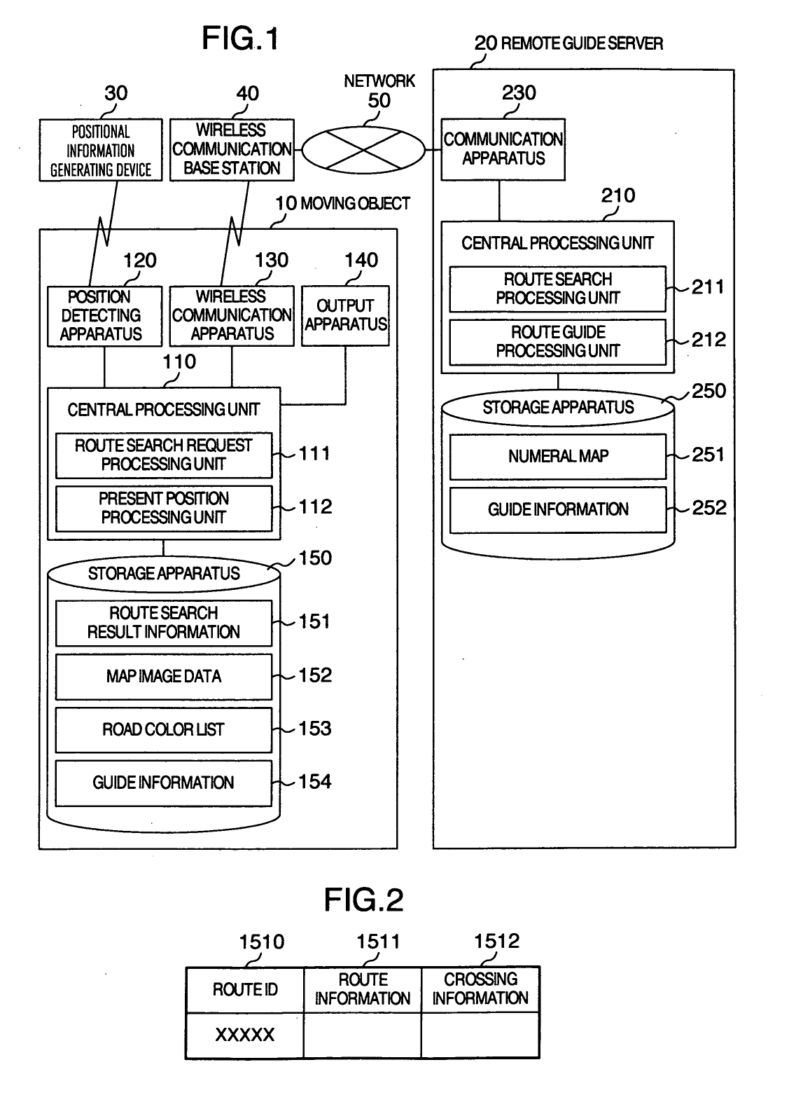

FIG. 1 is a structural diagram of a remote guide system designed for a moving object. As shown in the drawing, the remote guide system designed for the moving object contains a moving object 10, a remote guide server 20, a positional information generating device 30, a wireless communication base station 40, and a network 50. The remote guide server 20 provides route information and guide information with respect to the moving object 10. The positional information generating device 30 generates information used to detect the own position of a moving object from an external unit as to the moving object. The wireless communication base station 40 corresponds to a connection destination of a wireless communication line connected by the moving object 10. The network 50 connects the remote guide server 20 to the wireless communication base station 40. The moving object 10 communicates with the remote guide server 20 via the wireless communication base station 40 and the network 50. Generally speaking, plural sets of the wireless communication base stations 40 are connected via the network 50 to one set of the remote guide server 20. Also, the wireless communication base station 40 can simultaneously communicate with a plurality of the moving objects 10 by multiplex communication systems such as time division multiplexing and frequency division multiplexing.

The moving object 10 may be realized as, for instance, a car navigation system, a PND (Personal Navigation Device), an Ultra-Mobile PC, a portable telephone, and the like, or vehicles equipped with these wireless communication apparatuses. The remote guide server 20 may be contained as a partial function of a telematics service providing server, or a general-purpose ASP (Application Service Provider) server. The above-described telematics service implies “a combination between telecommunication technique and information service.” More specifically, in Japan, the telematics service implies a merged service between the Internet and on-vehicle information wireless technique. The positional information generating device 30 may be realized as a positional information generating device installed on a roadside area, a GPS (Global Positioning System)-purpose satellite, or an optical beacon. The wireless communication base station 40 may be realized as a base station (access point) for a portable telephone, a PHS, a wireless LAN, or the like. The network 50 may be realized as a portable telephone network, or the Internet network.

In this example, the moving object 10 will be described as a vehicle which is equipped with the above-explained communication apparatus, and is connected to the remote guide server 20 by a wireless communication.

The moving object 10 is equipped with a position detecting apparatus 120, a wireless communication apparatus 130, an output apparatus 140, a storage apparatus 150, and a central processing apparatus (CPU) 110. The position detecting apparatus 120 detects a position of the moving object 10 by an apparatus corresponding to the positional information generating device 30 such as a GPS system and an optical beacon, or by a self-contained navigation apparatus such as a vehicle speed pulse and a gyroscope. The wireless communication apparatus 130 is realized as a portable telephone, a PHS, a wireless LAN, or the like. The output apparatus 140 is realized as a liquid crystal display, a speaker, or the like. The storage apparatus 150 is realized as a hard disk, a flash memory, or the like, which is employed so as to store thereinto map image data 151 and the like. The central processing apparatus (CPU) 110 is connected to the position detecting apparatus 120, the wireless communication apparatus 130, the output apparatus 140, the storage apparatus 150, and the like in order to request the remote guide server 20 to search a route, and to process information received from the remote guide server 20.

The central processing apparatus 110 contains a route search request processing unit 111 and a present position processing unit 112. The route search request processing unit 111 transmits positional information about a departing place and a target place to the remote guide server 20, acquires route search result information 151 from the remote guide server 20, and stores the acquired route search result information 151 in the storage apparatus 150. The present position processing unit 112 reads map image data 152 corresponding to the relevant position from the positional information of the moving object 10 acquired from the position detecting apparatus 120, retrieves a road color list 153 on the map image data 152, corrects the positional information in such a manner that the corrected positional information may appear on a road, and outputs guide information 154 by utilizing the output apparatus 140 in response to the corrected positional information and guide information 154 acquired from the remote guide server 20.

The remote guide server 20 contains a communication apparatus 230, a storage apparatus 250, and a central processing apparatus (CPU) 210. The communication apparatus 230 is employed in order to be connected to the network 50. The storage apparatus 250 is realized as a hard disk, or the like so as to store thereinto numeral map 251, guide information 252, and the like. The central processing apparatus 210 is connected to the communication apparatus 230 and the storage apparatus 250 so as to execute a route search and the like.

The central processing apparatus 210 contains a route search processing unit 211 and a route guide processing unit 212. The route search processing unit 211 receives positional information of a departing place and positional information of a target place, which are transmitted from the moving object 10, by employing the communication apparatus 230, and searches a route by employing the numeral map 251 stored in the storage apparatus 250. The route guide processing unit 212 forms guide information 252 from the route guide result, and stores the formed guide information 252 in the storage apparatus 250. In the present embodiment mode, for the sake of easy understandings, although a description is made of one set of the moving object 10 as a subject matter, the guide information 252 is stored in the storage apparatus 250 in such a manner that the guide information 252 can be processed with respect to each of the moving objects 10.

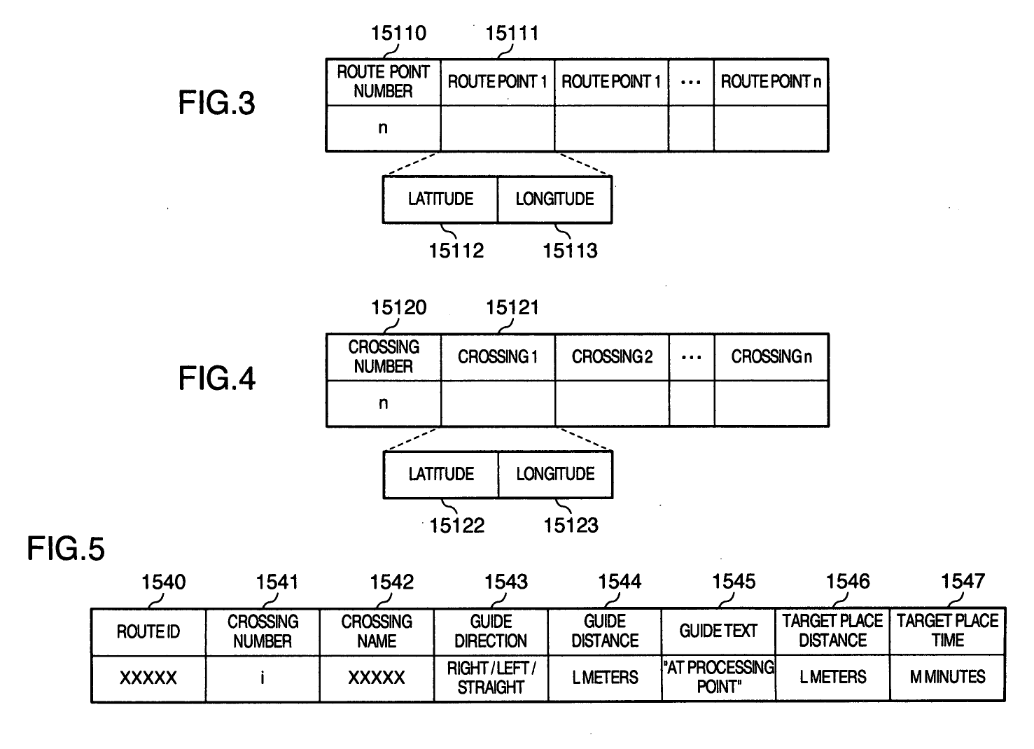

FIG. 2 is a diagram for showing one example of the route search result information 151 which is produced by the remote guide server 20 and is transmitted to the moving object 10. Items of the route search result information 151 are a route ID 1510, route information 1511, crossing information 1512, a group number 1513, a group ID 1514, and a spare flag 1515. The route ID 1510 identifies a route. The route information 1511 indicates a route from a departing place to a target place. The crossing information 1512 indicates a point on the route where a guidance is required. The group number 1513 represents a number of portions when the route is divided. The group ID 1514 shows a sequential number of a portion when the route is divided. The spare flag 1515 is to judge whether the relevant route corresponds to the route from the departing place to the target place, or a spare route provided when the moving object 10 is deviated from the route. In order to judge two sorts of routes, namely an original route and the spare route, the spare flag 1513 is assumed as “0” in case of the original route, and is assumed as “1” in case of the spare route. In such a case that the route is divided, the relevant ID contained in the route ID 1510 has a plurality of group IDs 1514. Also, the spare flag 1513 with respect to one ID contained in the route ID 1510 necessarily has only a value of “0”, or values of “0” and “1.” A content of the route information 1511 is indicated in FIG. 3. A content of the crossing information 1512 is shown in FIG. 4.

FIG. 3 is a diagram for indicating one example of the route information 1511 contained in the route search result information 151. The route information 1511 is indicated by a single line made by connecting a plurality of points with each other. Items of the route information 1511 are a route point number 15110 and route points (1 to “n”: “n” being integer larger than, or equal to 1) 15111. The route point number 15110 indicates a number “n” of points of a route. The route points 15111 show the points on the route. One route point 15111 for indicating a point on the route is constituted by latitude 15112, longitude 15113, a crossing number 15114, and a guide distance 15115. The crossing number 15114 represents a number “i” (1 to “n”: “n” being integer larger than, or equal to 1) of a point where a guidance is required when a guiding message is outputted at the relevant point. The guide distance 15115 shows a distance defined from the relevant point up to another point which is indicated by the crossing number 15114 when the guide message is outputted at the relevant point. In other words, a single line where the respective route points 15111 are sequentially connected to each other constitutes the route. The crossing number 15114 and the guide distance 15115 have values only at a point where a guiding message is outputted, and have no value at points other than the above-described point.

FIG. 4 is a diagram for showing one example of the crossing information 1512 contained in the route search result information 151. Items of the crossing information 1512 are a crossing number 1512 which indicates a number “n” of crossings, and crossings 15121 (1 to “n”: “n” being integer larger than, or equal to 1) which represent positions of the crossings. One crossing 15121 indicatives of a position of a crossing is constructed by employing latitude 15122 and longitude 15123.

FIG. 5 is a diagram for indicating one example of the guide information 154 which is produced by the remote guide server 20 and is transmitted to the moving object 10. Items of the guide information 154 are a route ID 1540, a crossing number 1541, a crossing name 1542, a guide direction 1543, a guide distance 1544, a guide text 1545, a target place distance 1546, and a target place time 1547. The route ID 1540 identifies a route. The crossing number 1541 shows a number “i” (1 to “n”: “n” being integer larger than, or equal to 1) of a point where a guidance is required on the route of the route ID 1540. The guide direction 1543 indicates a guiding direction at the relevant point. The guide distance 1544 shows a distance defined from the relevant point at which the guiding message is outputted. The guide text 1545 represents a content of the guiding message at the relevant point. The target place distance 1546 indicates a distance defined from the relevant place up to a target place. The target place time 1547 shows a time which is taken from the relevant place to the target place.

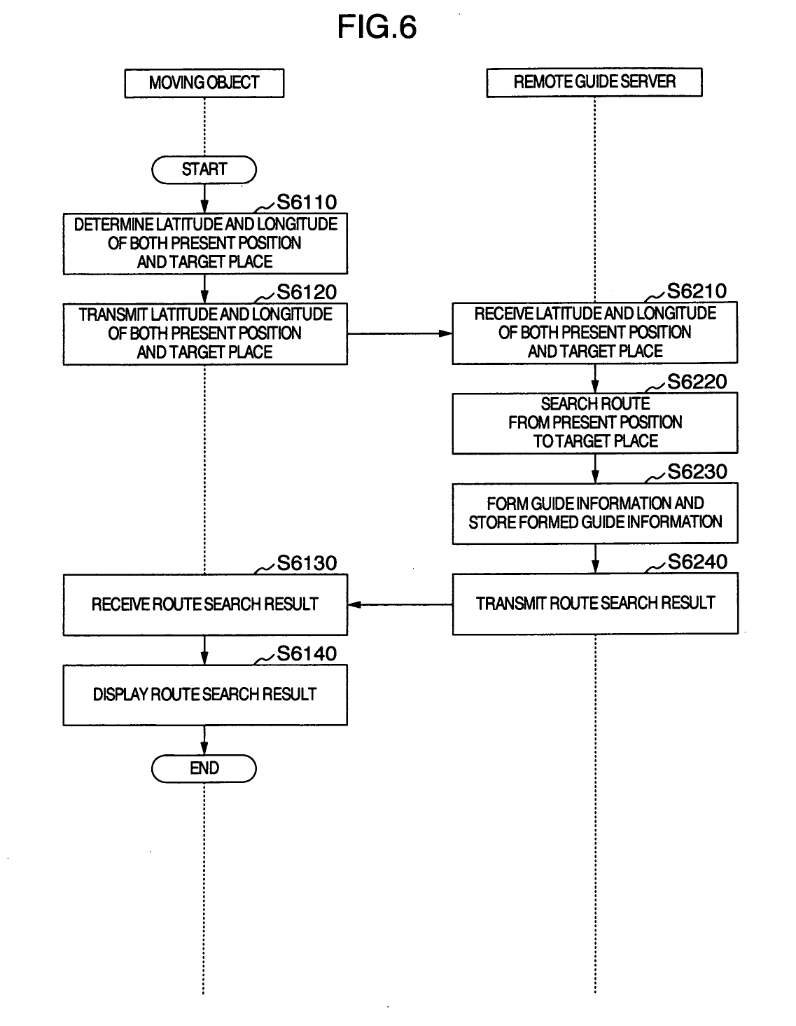

FIG. 6 is a flow chart in which process operations (route search request processing unit 111) of the central processing unit (CPU) 110 mounted on the moving object 10, and process operations (route search processing unit 211 and route guide processing unit 212) of the central processing unit (CPU) 210 mounted on the remote guide server 20 search routes. The route search request processing unit 111 is initiated when a user who utilizes the moving object 10 issues a request, and then commences the processing operations thereof. Alternatively, the route search request processing unit 111 may be initiated by that the moving object 10 is deviated from a route and the present position processing unit 112 of the moving object 10 judges the route deviation, and then may commence the process operations thereof.

The route search request processing unit 111 of the moving object 10 accepts the request of the user who utilizes the moving object 10, and determines latitude and longitude of both a present position and a target place (S6110). As methods for determining the target place, the target place may be designated from a map displayed on the output apparatus 140 of the moving object 10; the target place may be designated by retrieving an institution database stored in the storage apparatus 150 of the moving object 10, while the institution database is constituted by names of institutions, addresses, telephone numbers, latitude, longitude, and the like; and the target place may be retrieved via the Internet so as to be designated. Alternatively, the route search request processing unit 111 of the moving object 10 may determine latitude and longitude of both a present position and a target place by that the present position processing unit 112 of the moving object 10 judges whether or not a route is deviated. The target place of this alternative case is assumed as a target place determined in such a manner that the user who utilizes the moving object 10 finally issues a request. In the case that the latitude and the longitude of the present position and the target place are not present on a road, the latitude and the longitude may be alternatively corrected in such a manner that the corrected latitude and longitude may appear on the road by employing the present position processing unit 112.

The route search request processing unit 111 of the moving object 10 transmits the latitude and longitude of the present position and the target place determined in S6110 to the remote guide server 20 by employing the wireless communication apparatus 130 (S6120). Alternatively, the route search request processing unit 111 may transmit the determined latitude and longitude of the present position and the target place in combination with resolution of route information to the remote guide server 20 in response to resolution of a map which is outputted to the user.

The route search processing unit 211 of the remote guide server 20 receives the latitude and the longitude of both the present position and the target place, which are transmitted by the moving object 10 (S6210).

The route search processing unit 211 of the remote guide server 20 executes a route search by employing the numeral map 251 stored in the storage apparatus 250 of the remote guide server 20 so as to produce route information 1511 shown in FIG. 3 (S6220). In the case that the moving object 10 has transmitted the resolution of the route information, the route search processing unit 211 adjusts the number of route points of the route information 1511 in response to the transmitted resolution. As methods for adjusting the number of route points, the route search processing unit 211 may adjust the number of route points based upon map data every resolution, which have been previously held by the numeral map 251; after detailed route information has been once formed, the route search processing unit 211 may uniformly thin points; and alternatively, the route search processing unit 211 may thin points every interval between crossings. Also, in order to previously secure such a case that a user deviates from a route while the user is guided to a target place, the route search processing unit 211 previously extracts places where the user may easily deviate from the route, searches a route defined from the place where the user has deviated from the route up to the previously produced route, and again produces the route information 1511. At this time, as to the route ID 1510, the same ID as that of the previously produced route is set, and the spare flag 1515 is set to “1.” As methods for extracting the place where the user may easily deviate from the route, the route search processing unit 211 may extract all crossings which are located within, for instance, 100 meters from the previously produced route; the route search processing unit 211 may extract a crossing located in front of such a crossing where a guidance is required; and alternatively, the route search processing unit 211 may extract such a preceding crossing through which the user goes straight on without turning the crossing where the guidance is required.

The route guide processing unit 212 of the remote guide server 20 extracts such a point that a guidance is required on the route based upon the route information 151 produced in S6220, produces both crossing information 1512 shown in FIG. 4 and guide information indicated in FIG. 5, and stores the guide information shown in FIG. 5 in the storage apparatus 250 of the remote guide server 20 as the guide information 252 (S6230). In order that the previously produced guide information is notified to the user in advance, the route guide processing unit 212 may alternatively set numbers of the relevant crossings to the crossing number 15114 and also may set 600 m, 300 m, and 100 m to the guide distance 15115 with respect to three route points corresponding to points of 600 m, 300 m, 100 m, which are located in front of the crossing where the guidance is required among the route information 1511 produced in S6220. Further, the guide text 1545 of the above-described guide information 252 may be alternatively constructed of speech data.

The route search processing unit 211 of the remote guide server 20 produces route search result information indicated in FIG. 2 based upon both the route information 1511 produced in S6220 and the crossing information 1512 produced in S6230, and replies the produced route search result information with respect to the moving object 10 which has transmitted the latitude and the longitude of the present position and the target place (S6240). Alternatively, when the route search result information is replied to the moving object 10, the route search processing unit 211 may also apply thereto the guide information 252 produced in S6230. Further, the route search processing unit 211 may alternatively divide the above-described route search result information in the unit of a group, and may alternatively reply only a portion of the divided information groups. As methods for dividing the above-explained route search result information in the unit of the group, the route search result information may be divided every predetermined data size, may be alternatively divided every a distance of a predetermined route, and further may be alternatively divided every number of predetermined crossings.

The route search request processing unit 111 of the moving object 10 receives the route search result information shown in FIG. 2 from the remote guide server 20, and stores the received route search result information as the route search result information 151 in the storage apparatus 150 of the moving object 10 (S6130).

The route search request processing unit 111 of the moving object 10 displays the route search result information 151 on a map which has been displayed on the output apparatus 140 of the moving object 10, and accomplishes the route search request process operations (S6140). At this time, in such a case that the latitude and the longitude of the route information 1511 are not present on the road, the route search request processing unit 111 may correct the latitude and the longitude of the route information 1511 in such a manner that these latitude and longitude may appear on the road by employing the present position processing unit 112.

With execution of the above-explained route search request process operations, the moving object 10 can display the route search result by employing the guide information without receiving the map data from the route guide server 20.

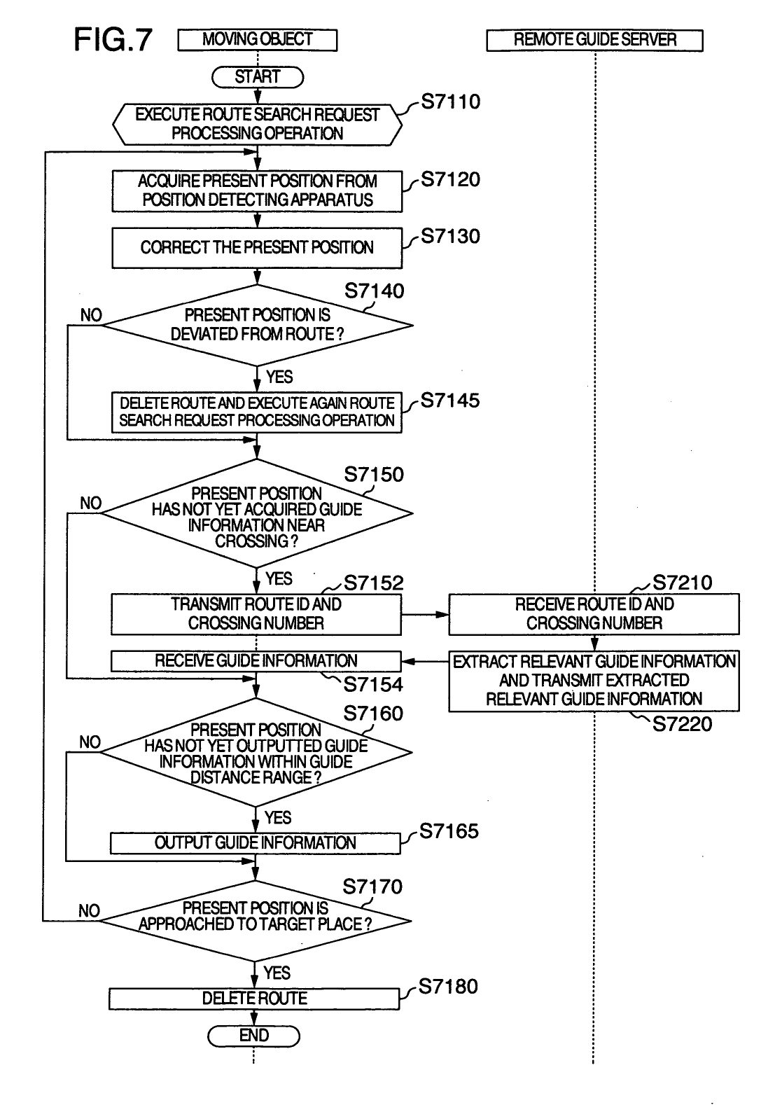

FIG. 7 is a flow chart in which process operations (present position processing unit 112) of the central processing unit (CPU) 110 mounted on the moving object 10, and process operations (route guide processing unit 212) of the central processing unit (CPU) 210 mounted on the remote guide server 20 guide routes. The present position processing unit 111 is initiated by a timer mounted on the moving object 10, and then commence the process operations thereof.

The user who utilizes the moving object 10 previously executes the flow chart of the route search shown in FIG. 6 (S7110). When the moving object 10 issues a request to the remote guide server 20, for instance, in such a case that an entire route is wanted to be grasped, the moving object 10 issues the request under the condition that resolution of route information is coarse, and in such a case that the user is guided while the user is moved, the moving object 10 issues the request under the condition that resolution of the route information is high.

The present position processing unit 112 of the moving object 10 measures both latitude and longitude by employing the position detecting apparatus 120, for example, every time 1 second elapses (S7120). Although the interval for measuring the latitude and the longitude is set to 1 second in this example, the internal may be set to, for instance, 0.5 seconds, or 2 seconds.

The present position processing unit 112 of the moving object 10 corrects the latitude and the longitude measured in S7120 in such a manner that the corrected latitude and longitude may appear on a road of a map (S7130). A flow chart of a correcting process operation will be discussed later.

The present position processing unit 112 of the moving object 10 diagnoses whether or not the present position corrected in S7130 is separated from the route by a distance longer than, or equal to, for instance, 200 m (S7140). The route is indicated by the route search result information 151 acquired in S7110 and stored in the storage apparatus 150 of the moving object 10. If the corrected present position is separated from the route, the process operation is advanced to S7145. If the corrected present position is not separated from the route, the process operation is advanced to S7150. A description will now be made of one example of methods for calculating the distance separated from the route. In this example, the present position corrected in S7130 is assumed as a point “A.” Firstly, a route point “i” which is located at the nearest distance from the point “A” is retrieved from the route points shown in FIG. 3 contained in the route search result information 151 stored in the storage apparatus 150 of the moving object 10. When an angle defined by the route point “i”, the point “A”, and one preceding route point “i−1” of the route point “i” is compared with another angle defined by the route point “i”, the point “A”, and one succeeding route point “i+1” of the route point “i”, such a smaller route point (either “i−1” or “i+1”) located adjacent to the route point “i” is assumed as a point “B.” Then, such a point is assumed as a point “C”, which is orthogonally intersected with a vertical line drawn from the point “A” with respect to a line segment for connecting the route point “i” to the point “B.” Since a distance between the point “A” and the point “C” is calculated, a distance between the present position and the route may be obtained. Alternatively, a distance between the point “A” and the route point “i” located at the nearest distance from the point “A” may be simply assumed as the distance between the present position and the route. In this example, although the reference of the distance deviated from the route is set to 200 m, the reference may be alternatively selected to be, for instance, 100 m, or 300 m.

In S7140, in the case that the present position is separated from the route by a distance longer than, or equal to the reference distance of the deviation distance, the present position processing unit 112 of the moving object 10 extracts a route containing the present position, in which the value of the spare flag 1515 is “1”, from the route search result information 151 stored in the storage apparatus 150 of the moving object 10, and the present position processing unit 112 sets the value of the spare flag 1515 of the route from the present position to the target place to “0”, and also sets the values of the spare flags 1515 other than the first-mentioned spare flag 1515 to “1.” When such a route containing the present position, in which the value of the spare flag 1515 is “1”, is not present in the above-described route search result information 151, the present position processing unit 112 discards the route search result information 151 stored in the storage apparatus 150 of the moving object 10, executes the flow chart of the route search shown in FIG. 6, and stores newly acquired route search result information in the storage apparatus 150 of the moving object 10 (S7145). It should be noted that a departing place at this time is assumed as the present position, and a target place is assumed as the target place which has been selected by the user who utilizes the moving object 10.

In the case that the guide information 154 related to a crossing through which the moving object 10 subsequently passes has not yet been stored in the storage apparatus 150 of the moving object 10, the present position processing unit 112 of the moving object 10 diagnoses whether or not the present position corrected in S7130 is located within, for instance, 5000 m from the crossing through which the moving object 10 subsequently passes contained in the route search result information 151 stored in the storage apparatus 150 of the moving object 10 (S7150). If the corrected present position is located within the reference range, then the process operation is advanced to S7152, whereas if the corrected present position is located outside the reference range, then the process operation is advanced to S7160. A description will now be made of one example of a method for calculating the distance up to the crossing through which the moving object 10 subsequently passes. In this method, the present position corrected in S7130 is assumed as a point “A.” Also, the crossing through which the moving object 10 subsequently passes is assumed as a point “B.” Firstly, the present position processing unit 112 retrieves such a route point “i” which is located at the nearest point from the point “A” within the route points shown in FIG. 3 contained in the route search result information 151 stored in the storage apparatus 150 of the moving object 10, and calculates a distance “L0” between the point “A” and the route point “i.” Similarly, the present position processing unit 112 calculates lengths of line segments up to the point “B” in such a manner that a distance “L1” between the route point “i” and the route point “i+1”, and another distance “L2” between the route point “i+1” and the route point “i+2” are calculated. Since these lengths of the line segments are added to each other, the present position processing unit 112 can calculate the distance from the present position up to the crossing through which the moving object 10 subsequently passes. Alternatively, a straight line distance between the point “A” and the point “B” may be simply defined as the distance defined from the present position up to the crossing through which the moving object 10 subsequently passes. In this example, although the reference of the distance up to the crossing through which the moving object 10 subsequently passes is set to 1000 m, the reference distance may be alternatively set to, for example, 1000 m, or 10000 m. Furthermore, the present position processing unit 112 may not diagnose whether or not the distance up to the crossing through which the moving object 10 subsequently passes is present within the reference distance, but may alternatively diagnose whether or not the moving object 10 has passed the crossing. In other words, if the moving object 10 has passed the crossing, then the process operation is advanced to S7152, whereas if the moving object 10 has not yet passed the crossing, then the process operation is advanced to S7160.

When the present position is entered to the range of the reference distance up to the crossing through which the moving object 10 subsequently passes in S7150, the present position processing unit 112 of the moving object 10 transmits both the route ID 1510 contained in the route search result information 151 stored in the storage apparatus 150 of the moving object 10, and the crossing number of the crossing “B” through which the moving object 10 subsequently passes with respect to the remote guide server 20 by employing the wireless communication apparatus 130 (S7152).

The route guide processing unit 212 of the remote guide server 20 receives the route ID 1510 and the crossing number transmitted from the moving object 10 (S7210).

The route guide processing unit 212 of the remote guide server 20 extracts guide information which is coincident with the above-described route ID 1510 and the above-explained crossing number from the guide information 252 stored in the storage apparatus 250 of the remote guide server 20 in S6230, and replies the extracted guide information with respect to the moving object 10 which has transmitted the route ID 1510 and the crossing number (S7220).

The present position processing unit 112 of the moving object 10 receives the guide information shown in FIG. 5 from the remote guide server 20, and stores the received guide information as the guide information 154 in the storage apparatus 150 of the moving object 10 (S7154).

In such a case that the guide information 154 related to the crossing through which the moving object 10 subsequently passes has not yet been outputted by the output apparatus 140 of the moving object 10, the present position processing unit 112 of the moving object 10 judges whether or not the present position corrected in S7130 is located within a guide output distance (S7160). If the corrected present position is located within the guide output distance, then the process operation is advanced to S7165, whereas if the corrected present position is located outside the guide output distance, then the process operation is advanced to S7170. The guide output distance is such a distance between a present position and a crossing through which the moving object 10 subsequently passes, and is acquired from the guide distance 15115 of the route information shown in FIG. 3. Alternatively, the guide output distance may be acquired from the guide distance 1544 of the guide information shown in FIG. 5. In this case, as a method for calculating the distance from the present position up to the crossing through which the moving object 10 passes, the same calculating method as that described in S7150 is employed.

In the case that the present position is entered to the range of the guide output distance in S7160, the present position processing unit 112 of the moving object 10 outputs guide information 154 by employing the output apparatus 140 of the moving object 10 (S7165). As the guide information 154 to be outputted, there are, for example, the crossing name 1542 and the guide direction 1543 indicated in FIG. 5, and the like. Also, for example, the guide text 1545 shown in FIG. 5 may be outputted as speech by utilizing a TTS (Text to Speech) program. Alternatively, if the guide text 1545 corresponds to speech data, then this speech data may be reproduced. Further, such a distance calculated by adding the distance from the present position up to the crossing through which the moving object 10 subsequently passes to the target place distance 1546 shown in FIG. 5 may be alternatively outputted in the display mode as the distance from the present position up to the target place. Moreover, a time obtained by multiplying the target place time 1547 shown in FIG. 5 by such a value may be alternatively outputted in the display mode as a time required from the present position up to the target place, while the above-described value is obtained by dividing the distance from the present position up to the target place by the target distance 1546 shown in FIG. 5.

The present position processing unit 112 of the moving object 10 diagnoses whether or not the present position corrected in S7130 is located within a range of, for instance, 10 meters from a last crossing indicative of the target place contained in the route search result information 151 stored in the storage apparatus 150 of the moving object 10, or a last point of the partial route in the case that the route search result information 151 is divided (S7170). If the corrected present position is located in the range within 10 m from the target point, then the process operation is advanced to S7180. When the corrected present position is located within the range of 10 m from the last point of the partial route, if the present position processing unit 112 transmits the route ID 1510 contained in the route search result information 151 stored in the storage apparatus 150 of the moving object 10 and the next group ID 1514 to the remote guide server 20 by employing the wireless communication apparatus 130, then the present position processing unit 112 receives next guide information from the remote guide server 20, and then, stores the received next guide information as new guide information 154 in the storage apparatus 150 of the moving object 10. If the corrected present position is not located within the range of 10 m from either the target place or the last point of the partial route, then the process operation is advanced to S7120. A method for calculating the distance up to the last crossing constituting the target place, or the last point of the partial route is identical to the method described in S7150. In this example, although the reference of the distance up to the target place and the last point of the partial route is set to 10 m, the reference distance may be alternatively set to, for instance, 20 m, or 5 m.

In the case that the distance from the present position up to the target place is located within the reference distance in S7170, the present position processing unit 112 discards both the route search result information 151 and the guide information 152 stored in the storage apparatus 150 of the moving object 10, and then, accomplishes the route guide process operation (S7180).

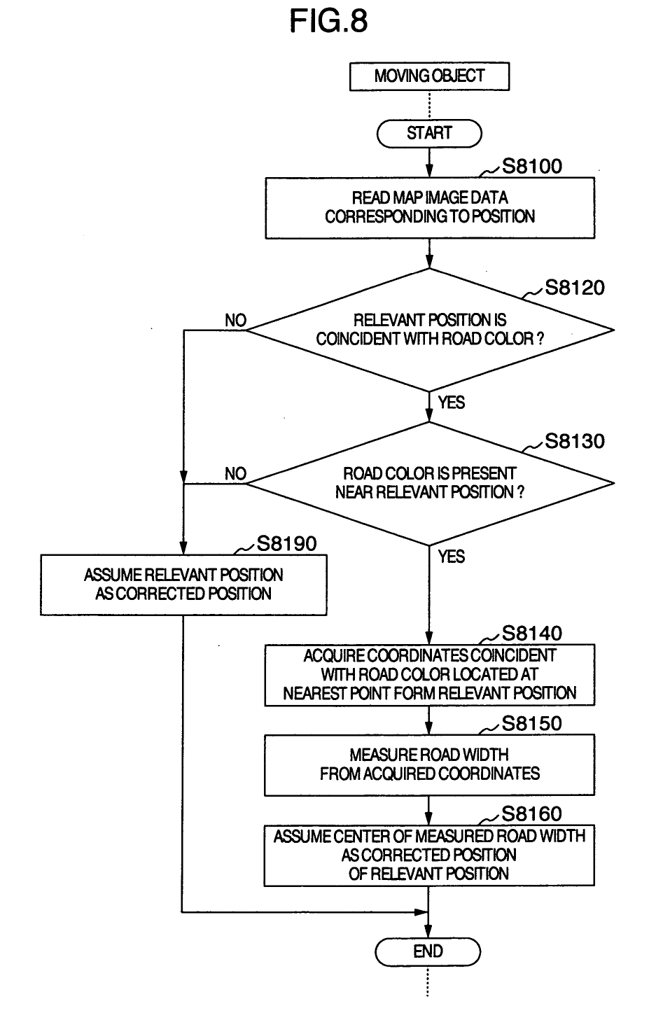

FIG. 8 is a flow chart in which process operations (present position processing unit 112) of the central processing unit (CPU) 110 mounted on the moving object 10 corrects an arbitrary point “A.”

The present position processing unit 112 of the moving object 10 previously stores thereinto a plurality of map image data 152, identification numbers of the map image data 152 and a corresponding table in the storage apparatus 150 of the moving object 10. The corresponding table causes the map image data 152 to be related to latitude and longitude, while contents of the corresponding table correspond to upper left XY coordinates of the map image data 152, upper right XY coordinates of the map image data 152, latitude/longitude corresponding to the lower left XY coordinates of the map data image 152, and latitude/longitude corresponding to the upper right XY coordinates of the map image data 152. The plurality of map image data 152 are all rectangles having the same dimensions.

The present position processing unit 112 of the map object 10 reads such a map image data 152 corresponding to the point “A” from the corresponding table for causing the latitude/longitude to be related to the map image data 152 stores in the storage apparatus 150 of the moving object 10 (S8110). Alternatively, the present position processing unit 112 may read 8 pieces of map image data 152 which surround the map image data 152 containing the point “A” in combination with the map image data 152 corresponding to the point “A.”

While the present position processing unit 112 of the moving object 10 employs the corresponding table which causes the map image data 152 to be related to the latitude/longitude, the present position processing unit 18 converts the latitude/longitude of the point “A” into XY coordinates, and extracts color information of the point “A” on the map image data 152, and then, compares to judge whether or not the extracted color information of the point “A” is coincident with any one color of the road color list 153 contained in the storage apparatus 150 of the moving object 10 (S8120). In such a case that the color of the point “A” is not coincident with any one color of the road color list 153, the process operation is advanced to S8130. In such a case that the color of the point “A” is coincident with any one color of the road color list 153, the process operation is advanced to S8190. In order to exclude points other than a road, not only one point of the point “A” may be investigated, but also a check may be made whether or not a total number of points is large which are coincident with the color of the road color list 153 within a range of, for instance, 5 pixels from the point “A.”

In such a case that the color of the point “A” is not coincident with any one color of the road color list 153 in S8120, the present position processing unit 112 of the moving object 10 checks whether or not any color of the load color list 153 stored in the storage apparatus 150 of the moving object 10 is present within, for example, 100 pixels from the point “A” (S8130). In the case that any color of the road color list 153 is present within 100 pixels from the point “A”, the process operation is advanced to S8140. In the case that any color of the road color list 153 is not present within 100 pixels from the point “A”, the process operation is advanced to S8190. In order to exclude points other than the road, the present position processing unit 112 may alternatively check not only one point, but also a total number of points which are coincident with the color of the road color list 153 within a range of, for example, 5 pixels.

When any color of the road color list 153 is present within 100 pixels from the point “A” in S8120, the present position processing unit 112 of the moving object 10 acquires coordinates of any color of the road color list 153 which is located at the nearest point from the point “A” (S8140). The acquired coordinates are assumed as a point “B.” Alternatively, in order to exclude points other than the road, such coordinates that a total number of points is large may be alternatively assumed as the point “B”, while these points are located at the nearest point from the point “A” and are coincident with the color of the road color list 153 within a range of, for instance, 5 pixels.

The present position processing unit 112 of the moving object 10 elongates a straight line from the point “B” to the opposite side from the point “A”, acquires not any colors of the road color list 153 on the above-described straight line, but a point located at the nearest point from the point “B”, and then, calculates a length from the point “B” to the acquired point (S8150). The acquired point is assumed as a point “C.” A length defined from the point “B” to the point “C” represents a width of the road.

The present position processing unit 112 of the moving object 10 defines a center point of a line segment for connecting the point “B” to the point “C” as a point “A′” after the correction, and accomplishes the process operation for correcting the arbitrary point “A” (S8160).

Either when the color of the point “A” is coincident with any color of the road color list 153 in S8120 or when there is no color of the road color list 153 within 100 pixels from the point “A” in S8130, the present position processing unit 112 defines the point “A” as a point “A′” after the correction, and accomplishes the process operation for correcting the arbitrary point “A” (S8190).

In accordance with the above-described embodiment mode, since the route search is carried out by the remote guide server and the guidance is performed on the side of the moving object, the communication need not be continuously carried out, but the precision of the route search can be improved and the variation can be readily expended.

Also, since the communication between the moving object and the server is mainly carried out when the route search is performed, the moving object can be operated without any adverse influence even when communication environments during movement are deteriorated.

Also, since both the route search function and the route guide function are installed in the server, the improvements in the precision of these functions, the addition of variations, and customizing of the variations can be realized without changes on the side of the moving object.

Furthermore, if such a map image data capable of identifying roads is available, then the moving object may merely require the above-described map image data, and may not necessarily require a numeral map in which roads are expressed based upon numeral values.

It should be further understood by those skilled in the art that although the foregoing description has been made on embodiments of the invention, the invention is not limited thereto and various changes and modifications may be made without departing from the spirit of the invention and the scope of the appended claims.

1. A remote guide system comprising:
a server including a route search processing unit for searching a route from a departing place to a target place so as to distribute a search result, and a route guide processing unit for distributing guide information for guiding a user from the departing place to the target place by passing the searched route; and
a processing apparatus connected to said server, and including a route search request processing unit for transmitting a request of a route search to said server, and a present position processing unit for guiding the user based upon the guide information acquired from said server.

2. A remote guide system as claimed in claim 1 wherein:
said route search processing unit distributes a sequence of points of both latitude and longitude which constitute the route as route information in response to a request issued from said processing apparatus.

3. A remote guide system as claimed in claim 1 wherein:
said route search processing unit can change a smoothness of a shape of the route by changing a sequence of points of both latitude and longitude which constitute the route information in response to a request issued from said processing apparatus.

4. A remote guide system as claimed in claim 1 wherein:
said route search processing unit distributes said guide information and said route information, which are limited to a peripheral area of the present position in response to a request issued from said processing apparatus.

5. A remote guide system as claimed in claim 1 wherein:
said route search processing unit previously extracts a place where a present position may be easily deviated from an original route in order to secure such a case that the present position is deviated from the original route, searches a route from the place where the present position has been deviated from the original route up to the original route, and distributes the searched route by being added to said guide information.

6. A remote guide system as claimed in claim 1 wherein:
in response to a request issued from said processing apparatus, said route guide processing unit distributes said guide information on the route by dividing said guide information in the unit of a guide point.

7. A remote guide system as claimed in claim 1 wherein:
in response to a request issued from said processing apparatus, said route guide processing unit distributes said guide information as speech data.

8. A remote guide system as claimed in claim 1 wherein:
said present position processing unit calculates a distance between the present position and a route based upon route information acquired from said server so as to judge whether or not the present position is deviated from the route.

9. A remote guide system as claimed in claim 1 wherein:
said present position processing unit calculates a distance between the present position and a crossing through which the user subsequently passes based upon crossing information acquired from said server, which indicates a point to be guided, so as to judge timing at which said guide information is outputted.

10. A remote guide system as claimed in claim 1 wherein:
in response to a request issued from said processing apparatus, said route guide processing unit distributes said guide information by adding thereto timing information indicative of such a timing for outputting said guide information to a specific point contained in said route information; and
said present position processing unit outputs said guide information based upon said timing information acquired from said server.

11. A remote guide system as claimed in claim 1 wherein:
said present position processing unit acquires said guide information related to a subsequent crossing from said server based upon crossing information acquired from said server, which indicates a point to be guided, at timing when the user passes through the crossing.

12. A remote guide system as claimed in claim 1 wherein:
said present position processing unit analyzes map image data held by said processing apparatus, and corrects the analyzed map image data in such a manner that an arbitrary point may appear on a road located at the nearest point from said arbitrary point on the map image data.

13. A guide method of a processing apparatus wherein:
said processing apparatus corrects a present position by employing map image data, and guides a user of said processing apparatus based upon guide information acquired from said server.

14. A remote guide system as claimed in claim 1 wherein:
said route search request processing unit determines latitude and longitude of both the departing place and the target place in response to said request; and
said present position processing unit guides the user after the departing place determined by said route search request processing unit is corrected.

15. A mobile apparatus comprising:
a communication unit for communicating with a server via a network;
a storage unit for storing thereinto map image data; and
a display unit for displaying thereon said map image data; wherein:
said mobile apparatus transmits information related to a departing place and a target place to said server, and receives guide information from the departing place up to the target place, which is searched in said server; and said mobile apparatus guides a user of the mobile apparatus based upon said received guide information without receiving map data from said server.
